(19) United States
(12) Patent Application Publication
(10) Pub. No.: US 2018/0075694 A1
(43) Pub. Date: Mar. 15, 2018

(54) SYSTEM AND METHOD FOR PROVIDING LOCATION-BASED GAMING EXPERIENCE

(71) Applicants: Anthony Frolov, Bell Canyon, CA (US); Mikhail Zadoyen, Granada Hills, CA (US); Igor Petrov, Saint Petersburg (RU); Aleksei Popov, Saint Petersburg (RU)

(72) Inventors: Anthony Frolov, Bell Canyon, CA (US); Mikhail Zadoyen, Granada Hills, CA (US); Igor Petrov, Saint Petersburg (RU); Aleksei Popov, Saint Petersburg (RU)

(21) Appl. No.: 15/260,378

(22) Filed: Sep. 9, 2016

(51) Int. Cl. G07F 17/32; A63F 13/35; A63F 13/25; A63F 13/33; A63F 13/335; A63F 13/32

(52) U.S. Cl. CPC G07F 17/3225; G07F 17/3211; G07F 17/3244; A63F 13/35; A63F 2300/407; A63F 13/33; A63F 13/335; A63F 13/32; G07F 17/3218; A63F 13/25

(57) ABSTRACT

A system for providing a gaming experience includes mobile devices in operative communication with the server. Each mobile device is configured to determine its geographical location so as to associate it with a geographical area such as a city. The mobile device obtains game object data associated with the geographical area and display the game object (e.g., a tree). The mobile device further enables a player to play games to acquire game points. The server causes modifying a portion of the game object (e.g., a branch on the tree) in accordance with the game points of the player such that the modified game object can be displayed on mobile devices of all players associated with the same geographical area. The game points of the player can be combined with game points of other players from the same geographical area and then compared to other geographical areas to determine a winner.

### BACKGROUND

### Technical Field

This disclosure generally relates to computer and video games. More particularly, this disclosure relates to a method and system for providing a location-based gaming experience on a mobile device based on a geographical location of a player.

### Description of Related Art

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

It has recently become popular to rank cities in different countries based on multiple criteria including an air quality index, environmental parameters, happiness of city habitants, development and modernization index, crime rate, education level, population demographics, and many more. For example, determining what is the greenest or cleanest city in the world is one of the hot topics for many people.

City inhabitants strive to make their city better than other cities and, oftentimes, people make donations or volunteer in city development projects. Unfortunately, it is not always easy to do for many city inhabitants because city development projects, environmental projects or charities may not be well known or can be time-consuming or expensive. In addition, children and teenagers may not freely participate in city development projects unless supervised by adults. For years, city inhabitants of all ages were seeking new and easier ways to make their city better, greener, and more convenient for living in a fun and easy manner, where the city ranking principles are the same for all cities, and the city ranks are readily available for everyone to view and compare.

### SUMMARY

This section is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

According to one aspect of the disclosure, a system for providing a location-based gaming experience is provided. The system comprises a server maintaining a plurality of pools of game points associated with a plurality of players and a plurality of geographical areas. The system also includes a first mobile device in operative communication with the server. The first mobile device includes a memory module and a processor configured to determine a first geographical location of a first player. The first geographical location is associated with a first geographical area (e.g., a city). Further, the first mobile device obtains from the server a first game object (e.g., a tree) associated with the first geographical area and displays the first game object to the first player. The first mobile device then associates the first player with a portion of the first game object (e.g., with a branch of the tree). Further, the first mobile device enables the first player to play one or more games to acquire game points. The server further causes modifying the portion of the first game object associated with the first player in accordance with the game points of the first player. The modified game object can be also displayable on mobile devices of other players associated with the first geographical area.

In certain embodiments, the system may include a second mobile device in operative communication with the server. The second mobile device includes a memory module and a processor configured to determine a second geographical location of a second player, where the second geographical location is associated with a second geographical area (e.g., a second city), which differs from the first geographical area. The second mobile device can obtain from the server a second game object associated with the second geographical area, display the second game object, associate the second player with a portion of the second game object, and enable the second player to play one or more games to acquire game points. The server further causes modifying the portion of the second game object associated with the second player in accordance with the game points of the second player, where the modified second game object can be displayed on mobile devices of other players associated with the first geographical area and on mobile devices of other players associated with the second geographical area.

In certain embodiments, the server is further configured to add the game points of the first player to a first pool of game points, add game points of other players from the first geographical area to the first pool of game points, repeatedly calculate a game points count in the first pool of game points, compare the game points count from the first pool with one or more other game points counts associated with players from other geographical areas and not associated with the first geographical area, and based on the comparing, select a winning geographical area among a plurality of geographical areas. The server can be further configured to award a monetary or non-monetary award to the winning geographical area.

In certain embodiments, the server is further configured to enable the first player to at least partially reverse the modification of the portion of the second game object associated with the second player based on game interactions or monetary purchases made by the first player. Similarly, in certain embodiments, the server is further configured to enable the second player to at least partially reverse the modification of the portion of the first game object associated with the first player based on game interactions or monetary purchases made by the second player.

According to another aspect of the disclosure, a method for providing a location-based gaming experience is provided. The method comprises the following steps: determining a first geographical location of a first player (where the first geographical location is associated with a first geographical area), obtaining a first game object associated with the first geographical area, displaying the first game object to the first player, associating the first player with a portion of the first game object, enabling the first player to play one or more games to acquire game points, and modifying the portion of the first game object associated with the first player in accordance with the game points. The modified game object can be displayed on mobile devices of other players associated with the same first geographical area.

In some embodiments, the first game object is displayed to the player using augmented reality. Moreover, the first game object can be a three-dimensional object.

In some embodiments, the method may further comprise adding the game points of the first player to a pool of game points, adding game points of other players from the first geographical area to the pool of game points, repeatedly calculating a game points count in the pool of game points, comparing the game points count with one or more other game points counts associated with players from other geographical areas not associated with the first geographical area, and, based on the comparing, selecting a winning geographical area among a plurality of geographical areas. In some embodiments, the method may further comprise awarding a monetary or non-monetary award to the winning geographical area.

In some embodiments, the method may further comprise associating the first player with the first geographical area and a first sub-geographical area, wherein the first sub-geographical area is smaller than the first geographical area and is located within the first geographical area. The method may further associate a first group of other players with the first sub-geographical area based on their geographical locations and enable to collectively modify the same portion of the first game object associated with the first player and the first group of other players based on game points acquired by the first player and the first group of other players. The first geographical area can refer to a city, a town, or a village, while the first sub-geographical area can refer to a street, a district or a neighborhood of the first geographical area.

In some embodiments, the first game object includes a tree and the portion of the first game object refers to a branch of the tree. The step of modifying of the portion of the first game object can include creating or editing one or more features of the branch of the tree. The features of the branch of the tree can include leaves of the tree.

In some embodiments, the method may further comprise enabling the first player to make monetary purchases and modifying the portion of the first game object based on the monetary purchases.

In yet additional embodiments, the method may further comprise determining a second geographical location of a second player (where the second geographical location is associated with a second geographical area), obtaining a second game object associated with the second geographical area, displaying the second game object using augmented reality, associating the second player with a portion of the second game object, enabling the second player to play one or more games to acquire game points, and modifying the portion of the second game object associated with the second player in accordance with the game points. The modified game object can be displayable on mobile devices of other players associated with the first geographical area and on mobile devices of other players associated with the second geographical area.

In some embodiments, the method may further comprise enabling the first player to at least partially reverse the modification of the portion of the second game object associated with the second player based on game interactions or monetary purchases made by the first player and enabling the second player to at least partially reverse the modification of the portion of the first game object associated with the first player based on game interactions or monetary purchases made by the second player.

In some embodiments, the method may further comprise assigning a predetermined status to the first player based on the game points and monetary transactions of the first player and providing additional games or game features to the first player based on the predetermined status to the first player.

According to yet another aspect of the disclosure, there is provided a non-transitory processor-readable medium having instructions stored thereon, which when executed by one or more processors, cause the one or more processors to implement the above recited method for providing a location-based gaming experience on a mobile device.

Additional objects, advantages, and novel features of the examples will be set forth in part in the description, which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

Embodiments are illustrated by way of example and not limitation in the figures of the accompanying drawings, in which like references indicate similar elements and in which:

FIG. 1 shows one example embodiment of a system for providing a location-based gaming experience;

FIG. 2 shows a process flow diagram showing a method for providing a location-based gaming experience according to an example embodiment;

FIG. 3 shows an example Graphical User Interface (GUI) for displaying a game object using augmented reality;

FIG. 4 shows an example GUI of an initial stage of a game;

FIG. 5 shows an example GUI of an advanced stage of the game; and

FIG. 6 is a computer system that may be used to implement the method for providing a location-based gaming experience.

### DETAILED DESCRIPTION OF EXAMPLE EMBODIMENTS

### Introduction

The following detailed description of embodiments includes references to the accompanying drawings, which form a part of the detailed description. Approaches described in this section are not prior art to the claims and are not admitted to be prior art by inclusion in this section. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical and operational changes can be made without departing from the scope of what is claimed. The following detailed description is, therefore, not to be taken in a limiting sense, and the scope is defined by the appended claims and their equivalents.

Aspects of the embodiments will now be presented with reference to a system and method for providing a location-based gaming experience. These system and method will be described in the following detailed description and illustrated in the accompanying drawings by various blocks, components, circuits, steps, operations, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, Central Processing Units (CPUs), digital signal processors (DSPs), field programmable gate arrays (FPGAs), programmable logic devices (PLDs), state machines, gated logic, discrete hardware circuits, and other suitable hardware configured to perform various functions described throughout this disclosure. One or more processors in the processing system may execute software, firmware, or middleware (collectively referred to as “software”). The term “software” shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, or any combination thereof. If implemented in software, the functions may be stored on or encoded as one or more instructions or code on a non-transitory computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage, solid state memory, or any other data storage devices, combinations of the aforementioned types of computer-readable media, or any other medium that can be used to store computer executable code in the form of instructions or data structures that can be accessed by a computer.

### Term Definitions

For purposes of this patent document, the terms “or” and “and” shall mean “and/or” unless stated otherwise or clearly intended otherwise by the context of their use. The term “a” shall mean “one or more” unless stated otherwise or where the use of “one or more” is clearly inappropriate. The terms “comprise,” “comprising,” “include,” and “including” are interchangeable and not intended to be limiting. For example, the term “including” shall be interpreted to mean “including, but not limited to.”

It should be also understood that the terms “first,” “second,” “third,” and so forth can be used herein to describe various elements. These terms are used to distinguish one element from another, but not to imply a required sequence of elements. For example, a first element can be termed a second element, and, similarly, a second element can be termed a first element, without departing from the scope of present teachings.

Moreover, it shall be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present.

The term “mobile device” shall be construed to mean any portable electronic device with a display, processor, memory, and a network interface. For example, mobile devices can include, but not limited to, a cellular phone, mobile phone, smart phone, tablet computer, laptop computer, personal digital assistant, music player, multimedia player, portable computing device, game console, gaming device, head-mounted display, wearable computer, television device, and so forth. In some embodiments, however, the term “mobile device” can be construed as broad as any computing device with networked functionality, and include, for example, a general-purpose computer, desktop computer, server, and workstation.

The term “augmented reality” shall be construed to mean a combination of real-world and computer-generated data, where computer-generated data is blended into real-world-sourced images in real time. For example, an augmented reality image can include two components: a background, which is a real-world-sourced image obtained in real time, and a foreground, which can refer to a game object (e.g., a computer-generate tree image) overlaying the background in the manner that a viewer can see the foreground and at least a part of the background not covered by the foreground.

The term “city” shall be construed to mean any human-inhabited area or settlement, which is recognized by a government or inter-government institution, as a village, town, city, metropolis, or megapolis.

The term “game object” shall be construed to mean a two-dimensional or three-dimensional image of a certain item, for example a tree or any other item including a planet, flower, and the like. Each player from a particular group of players can be enabled to modify one or more certain portions of the game object (but not the entire game object) as a result of his interaction with the game or as a progress on completing certain game levels, quests, missions, challenges, and so forth.

The term “game point” shall be construed to mean one or more of the following: virtual currency, real world currency, award points, virtual points, virtual travel miles, and score points.

### EXAMPLE EMBODIMENTS

The present teachings generally relate to “System 02:19” game available to play by players from any city in the world. This game may allow players from one city to compete as a group with players (or group of players) from other cities in determining whose city is greener, cleaner, and more comfortable to live in. The game play enables the players to make different actions, play games, complete challenges, missions, quests, goals, and adventures, as well as provide opinions, make monetary and non-monetary transactions or purchases, interact with each other, interact with game objects, and so forth, all for being better as a group from a particular city. Monetary contributions or payments of the players or sponsors are aggregated in a monetary fund and then can be awarded or transferred to one or more predetermined local organizations of the winning city and optionally non-winning cities based on certain predetermined criteria. The local organizations can spend money on environmental projects, city development projects, urbanistic projects, charities, and any other non-profit purposes. The ranking of the cities can be repeatedly calculated, for example, daily, weekly, monthly, quarterly, annually, and the like. For example, the ranking tables of the cities can be updated regularly at the same time such as at 02:19 am daily. Accordingly, the players can help their cities to be a better place of living simply by playing the game on a regular basis.

According to various embodiments of this disclosure, the gaming experience can be as follows. The players use their mobile devices and install a mobile game application, software application, or access a game web page using a browser. The mobile device determines its geographical location based on mobile device data, Global Navigation Satellite System (GNSS) signals, triangulation, or any other suitable method. Based on the geographical location of the player, the mobile device acquires from a server (e.g., a game server) data related to a game object associated with a city where the player is located. Accordingly, each city may be linked to a unique game object, which can be different from other game objects of other cities. The mobile device then displays the game object on its screen.

In certain embodiments, the game object can relate to a virtual tree, and it can be presented as a two-dimensional or three-dimensional image. In addition, in some embodiments, the game object can be displayed using augmented reality. In that case, a camera of the mobile device can acquire images of real world in real time such that they are displayed as a background, while the game object is shown as a foreground over the background. In alternate embodiments, however, the game object is displayed as overlaying a predetermined image or video. In some embodiments, the game object is associated with a particular and predetermined geo-location in the city. Accordingly, the game object can be seen in the augmented reality as linked to that predetermined geo-location. The design, shape or any other visual features of the game object depend on collective gaming results by a plurality of players from the same city. For this reason, there can be no game objects of the same design in different cities. The player can see and interact with the game object of his city, but can only city game objects of other cities.

The player can play games, complete tasks, challenges, missions, levels, and so forth. The games can be played individually by the player or collectively with other players (e.g., in a multiplayer mode). In the gameplay, the player acquires game points (e.g., virtual in-game currency) in the result of playing the games or completing tasks, challenges, missions, quests, and the like. For example, the player can earn game points for successful completion of games or quests. The game points of the player can be then aggregated in a pool along with game points of other players from the same city. Similarly, for each city, there can be many pools for collecting game points from players from different cities. The pools are then used to calculate total counts of the game points per predetermined period (e.g., daily, weekly, monthly, etc.). The counts are then compared with one another to rank the cities. In some embodiments, the players can be also ranked among the groups of the players from the same city. The city ranks are then used to determine a winning city. The winning city can get a monetary or non-monetary reward based on predetermined criteria. For example, one or more local non-for-profit organizations of the winning city can be given a monetary contribution for purposes of implementing city development projects, environmental projects or other projects in the winning city. The players can participate in the selection of projects or local non-for-profit organizations.

In addition to above, the gaming allows for visually modifying the game object based on the results of game, game points count, monetary or non-monetary transactions or purchases, and so forth. For example, when the player successfully completes a game mission, the game object can be visually modified by adding an additional leave or flower on a tree. Similarly, the player can purchase leaves or other graphical objects to be appeared on the tree.

In some embodiments, each player can be associated with a particular portion of the game object. For example, each player can be assigned with a branch of a tree. Accordingly, in the game play, the player can remain responsible for their portion of the tree and should make all efforts possible to positively modify (i.e., improve) that portion of the game object. In aggregate, when players form the same city work towards improvement of the game object, the game object can be visually modified. For example, the tree of a city can grow, acquire additional branches, leaves, flowers, fruits, animals, insects, and alike graphical objects. The more players play and interact with other, the faster the tree will grow.

In yet additional embodiments, the game can provide chats for the players to interact with one another or with other people. The players can also invite other people, such as friends, neighbors, and family members to participate in the game. In certain additional embodiments, the players of the same city can build teams and collectively participate in certain games, challenges, quests, tasks, and so forth.

Moreover, each city can be partitioned by districts, neighborhoods, streets, and any other sub-geographical areas. In the game, each sub-geographical area can be associated with a certain part of the game object. For example, each street can be associated with a certain branch of the tree. Accordingly, the players who live on that street are enabled to modify only that branch of the tree. In additional embodiments, there can be more than one sub-geographical area. For instance, districts can refer to large branches of the tree and streets can refer to small branches belonging to corresponding large branches of the tree.

In certain embodiments, each player can have a personal account of a predetermined type. The gameplay and game features can depend on the account type. In some embodiments, the account type depends on player's experience, age or selection. For example, the first account type includes an account tailored for children. With this account, children can play basic games and earn game points for creating or editing leaves on the tree. However, children would not be able to make monetary transactions.

The second account type can be tailored to teenagers. With this account, teenagers can play more games than children, and the games can be more complicated. Moreover, the teenagers can also make certain monetary or non-monetary transactions, for example, they can purchase leaves for the tree. Moreover, the teenagers can participate in fighting games. For these ends, the fighting games can offer the players to use animated characters, such as animals, bugs or insects that can fight with one another. In some embodiments, the animated characters can negatively act on the game object. For example, the players of one city can cause the animated characters to damage parts of the tree of another city. In this sense, the players can partially reverse the modification of the tree. However, the players of other city can have their own animated characters that could defense their tree from such negative impact.

The third account type can be tailored for those adults or gamers who like business simulation games or management simulation games. With this account, the players can be provided with tasks such as developing and maintaining a garden or farm for the purposes of acquiring game points. With the game points, the players can purchase leaves for their part of the tree or any other visual features.

The third account type can be tailored for those adults or gamers who like strategy games. Here, the players can enjoy playing complex management simulation games or real-time strategy games with the purpose of earning game points. Again, the players can purchase leaves for their part of the tree or any other visual features using the game points they earned.

As discussed above, the players can make certain money transactions. For example, the players can pay for game itself or monthly/annual fee. In other examples, the players can purchases of graphical features, such as leaves for the tree. Moreover, the players can make money transactions for passing certain levels, missions, challenges, and the like. In addition, the players can pay money to reverse modification or damage trees of other cities.

The money aggregated from all players can be collected in a fund or an account. Further, when one city wins, the server may cause automatic transaction of a certain portion of the aggregated money (e.g., 80%) to select organizations, which can include local government or non-for-profit organizations selected by the players. Moreover, the fund or account can get money from advertisement, sponsors or donators.

In yet additional embodiments of this disclosure, the players can be assigned with one or more predetermined statuses. The status can be assigned based on acquired game points or monetary transactions made by a particular player. For example, the player's statuses can include a “mayor,” “senator,” “commander,” and the like. Depending on the player's status, the player can be provided with certain additional games, challenges, features, tasks, quests, missions, abilities, which are not readily available to other players. Accordingly, in one embodiment, the most active player from a city can become a virtual mayor of that city to have more options to manage the growth of the tree of that city.

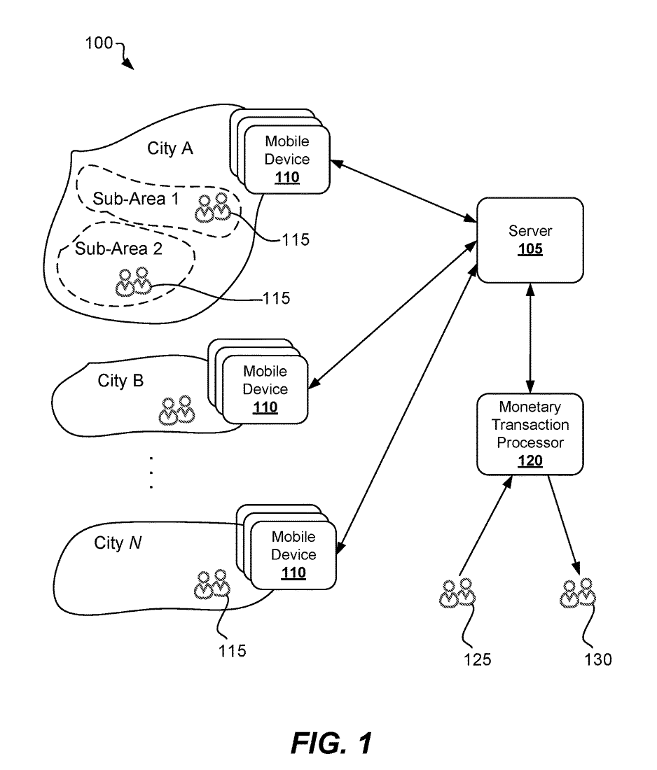

Referring now to the drawings, FIG. 1 shows one example embodiment of a system 100 for providing a location-based gaming experience. As shown in the drawing, the system 100 includes a server 105 and a plurality of mobile devices 110, which are in operative communication with the server 105 via one or more data networks. The data networks can refer to any wired, wireless, or optical network including, for example, the Internet, intranet, local area network (LAN), Personal Area Network (PAN), Wide Area Network (WAN), Virtual Private Network (VPN), cellular phone networks (e.g., Global System for Mobile (GSM) communications network, packet switching communications network, circuit switching communications network), Bluetooth radio, Ethernet network, an IEEE 802.11-based radio frequency network, Internet Protocol (IP) communications network, or any other data communication network utilizing physical layers, link layer capability, or network layer to carry data packets, or any combinations of the above-listed data networks. In some embodiments, the data networks include a corporate network, data center network, service provider network, mobile operator network, or any combinations thereof.

The mobile devices 110 can have installed a mobile game application or software game application suitable for executing at least some steps of method for providing a location-based gaming experience as described herein. In some embodiments, the server 105 can have a software application for executing at least some other steps of the method for providing a location-based gaming experience as described herein.

The mobile devices 110 are used by players 115 who live or temporary locate in different geographical areas. For example, as shown in FIG. 1, one group of mobile devices 110 are operated by players 115 who locate in a city “A,” while another group of mobile devices 110 are operated by other players 115 who locate in a city “B,” while yet another group of mobile devices 110 are operated by players 115 who locate in a city “C,” and so forth. Each city can be virtually linked to a particular game object such as a virtual tree, virtual planet, virtual country, virtual city, and the like. Each of the players 115 from one geographical area (e.g., one city) can view on their mobile devices 110 the same game object, while other players 115 from other geographical areas can view their respective game objects. In some embodiments, however, all players 115 can have a chance to review and compare the game objects of different geographical areas.

Further, in some embodiments, each city can be partitioned into one or more sub-geographical areas. For example, as shown in FIG. 1, the city “A” can have a sub-geographical area “A1,” a sub-geographical area “A2,” and so forth. Each sub-geographical area can refer to a district, neighborhood, street, avenue, city square, and the like. Accordingly, some of players 115 of the first group (i.e., those from city “A”) can be located in the sub-geographical area “A1,” some others of these players 115 can be located in the sub-geographical area “A2,” and so forth. As discussed above, players 115 of different sub-geographical areas can be associated with different parts of the game object, such as when they are associated with different branches of the same tree.

When players 115 play in the game, they play in multiple games, take and pass challenges, missions, levels, quests, game tasks, etc., for which they can earn game points. The players 115 can also control one or more virtual game characters to interact with other players 115 or virtual objects. In some embodiments, the players 115 can make transactions involving real-word currency or game points. For example, the players 115 can purchase game points with real-word currency. In another example, the players 115 can purchase game features, such as leaves for the tree, using real-word currency. The monetary transactions can be performed using credit cards, debit cards, prepaid cards, wire transfers, and so forth. In some additional embodiments, sponsors 125 can make donations or payments for advertising services or any other goods or services associated with the system 100. For the aforesaid ends, the server 105 can be in operative communication via one or more data networks with a monetary transaction processor 120 implemented with a remote or web server. In some embodiments, the monetary transaction processor 120 can include a credit card processor. Moreover, the monetary transaction processor 120 can include or be associated with one or more bank accounts for accumulating payments and donations. When the server 105 determines the ranks of geographical areas (e.g., cities), the server 105 can determine a winner and cause the monetary transaction processor 120 to provide a payment from the respective bank accounts to one or more local non-profit organizations or charities 130. The non-profit organizations or charities 130 can be preselected by the players 115. In some embodiments, each geographical area (e.g., a city) can be individually associated with one or more select non-profit organizations or charities 130.

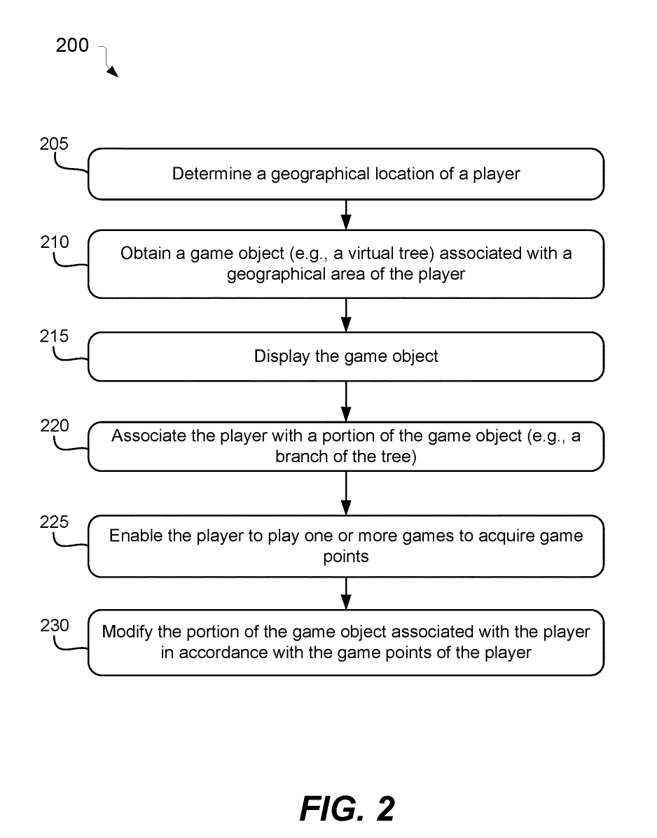

FIG. 2 is a process flow diagram showing a method 200 for providing a location-based gaming experience according to an example embodiment. The method 200 may be performed by processing logic that may comprise hardware (e.g., decision-making logic, dedicated logic, programmable logic, application-specific integrated circuit (ASIC), and microcode), software (such as software run on a general-purpose computer system or a dedicated machine), or a combination of both. In one example embodiment, the method 200 is implemented by the mobile device 110. In another embodiment, the method 200 is implemented by the server 105. In yet another example embodiment, the method 200 is implemented by bother mobile device 110 and the server 105. The steps of the method 200 may be implemented in an order different than described and shown in FIG. 2. Moreover, the method 200 may have additional steps not shown herein, but which can be evident for those skilled in the art from the present disclosure. The method 200 may also have fewer steps than outlined below and shown in FIG. 2.

The method 200 for providing a location-based gaming experience commences at step 205 with the mobile device 110 determining a geographical location of a player 115 who operates the mobile device 110. The geographical location can be determined by acquiring GNSS signals or retrieving the geographical location from mobile device operating data. The geographical location is associated with a particular geographical area such as a city.

At step 210, the mobile device 110 obtains a game object (e.g., a virtual tree) associated with the geographical area. The game object data can be obtained from the server 105. For these ends, the mobile device 110 can send a request to the server 105, where the request can include the determined geographical location. Responsive to the request, the server 105 can send corresponding game object data to the mobile device 110 for displaying and interacting.

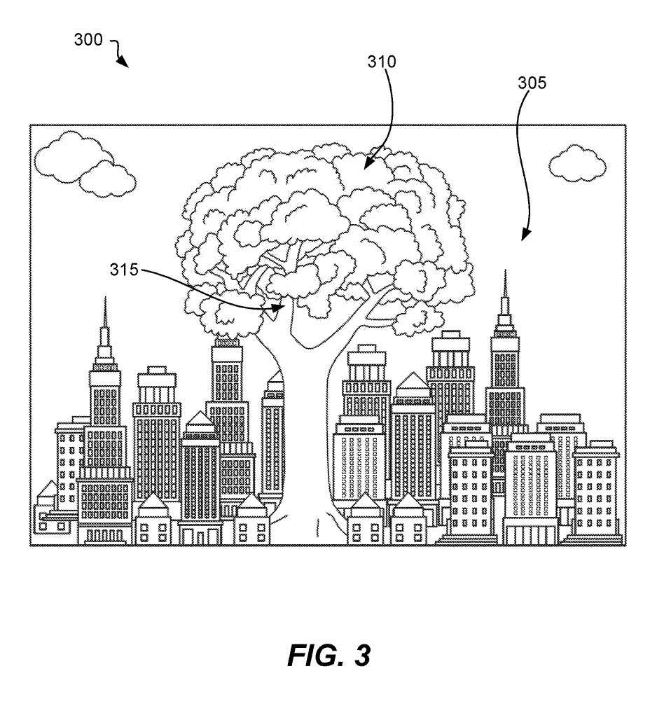

Accordingly, at step 215, the mobile device 110 displays the game object to the player 115. In some embodiments, the game object can be linked to a particular geo-location in the geographical area. Moreover, in some embodiments, the game object can be displayed using augmented reality. For example, FIG. 3 shows an example game GUI 300 displayable on the mobile device 110. The game GUI 300 includes a background 305, which refers to real-word image captured by a camera of the mobile device 100. The game GUI 300 also includes the game object 310 represented by a tree image. The game object 310 can be shown as a two dimensional image or three-dimensional image. The game object 310 can be also shown as a still image or animated images. In certain embodiments, branches 315 of the tree 310 can represent different sub-geographical areas such as city districts or streets.

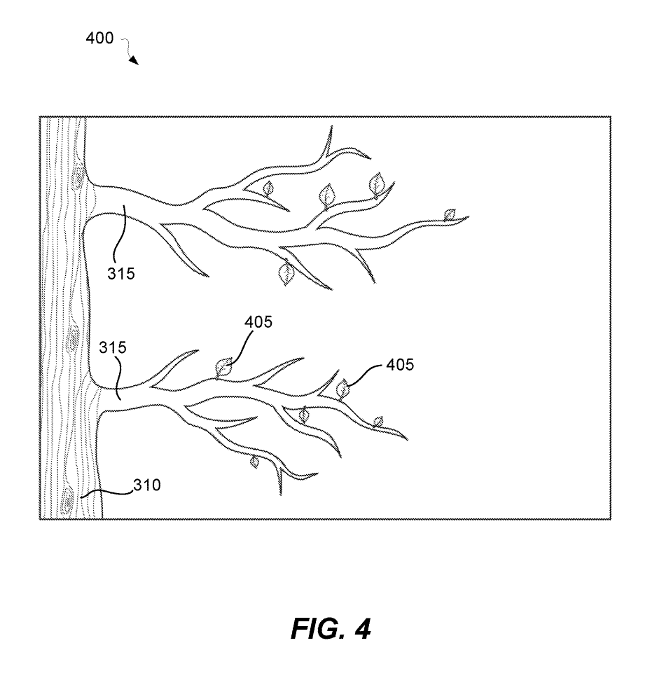

Referring back to FIG. 2, at step 220, the mobile device 110 or server 105 associates the player 115 with a portion of the game object 310. For example, the player 115 can be associated with one of the branches 315. For example, FIG. 4 shows a game GUI 400 illustrating the game object (tree) with at least two branches 315, which the player 115 can be associated with. The game GUI 400 represents one of initial moments of the game, when the branches 315 have no or little game features such as leaves 405.

Referring back to FIG. 2, at step 225, the mobile device 110 or server 105 enables the player 115 to play one or more games to acquire game points. The player 115 can take and pass certain levels, missions, quests, challenges, and so forth to earn game points. The player 115 can also perform monetary transactions to obtain game points.

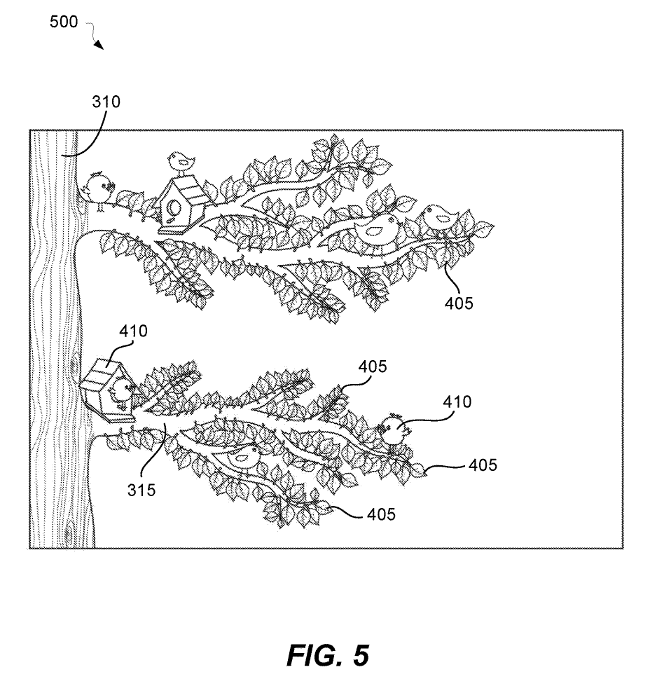

At step 230, the mobile device 110 or server 105 modifies the portion of the game object associated with the player 115 in accordance with the game points of the player 115. For example, with the advancement in the game, the player 115 can be rewarded with game features such as tree leaves 405. In addition, the player 115 can exchange the game points into game features such as tree leaves 405. Thus, in the course of the game, the player 115 improves the branch 315 by adding more and more leaves 405. FIG. 5 shows a game GUI 500 illustrating the game object (tree) at an advanced moment in the game. The GUI 500 includes at least two branches 315 filled with the leaves 405 and other game features 410 (e.g., animated characters). The server 105 can enable players 115 to collectively modify the same portion of the game object (e.g., one and the same branch 315). The modification can be based on game points acquired by all players associated with certain sub-geographical area. The modified game object can be displayable on mobile devices 110 of all players 115 associated with the same geographical area.

The steps 205-230 can be repeated to all players 115 from the same geographical area and other geographical areas. Further, the game points of the players 115 from the same geographical area, such as from the city “A,” are added and aggregated in a pool of game points maintained by the server 105. Similarly, game points of other players 115 from other geographical areas, such as from the city “B,” city “C,” etc., are added and aggregated in other pools of game points maintained by the server 105. The server 105 can repeatedly calculate total game points counts in each of the pools and then compare the game points counts with one another. Based on the comparing, the server selects a winning geographical area among a plurality of geographical areas. Thus, for example, when the players 115 of city A acquired more game points than players from any other city, city A wins. The determination of what geographical area has won the competition can be based on the game points acquired for a predetermined period such as one day, week, month, year, and so forth. Further, the server 105 can cause awarding a monetary or non-monetary award to the winning geographical area. For example, the server may cause the money transaction processor 120 or any other banking institution to transfer 80% of aggregated currency from a bank account to one or more select organizations to spend money on city development or development projects for the benefit of the winning geographical area.

In certain embodiments, some players 115 from one city can at least partially reverse the modification of a portion of game object associated with other players from another city. For these ends, players 115 can interaction with each other using game characters or by making monetary purchases. For example, one player 115 from city A can make a purchase transaction to damage one or more leaves or one or more branches of virtual tree of city B. In addition, some players 115 from city B can damage one or more leaves or one or more branches of virtual tree of city A when these players fight in a virtual game and win against players 115 from city A.

In yet more embodiments, each player 115 can be assigned with a predetermined status based on the game points and monetary transactions of this particular player. The status can be selected from a group comprising “mayor,” “commander,” “vice mayor,” and so forth. The players 115 that have a status assigned can have additional benefits in the game such as they can be provided with some additional games or game features.

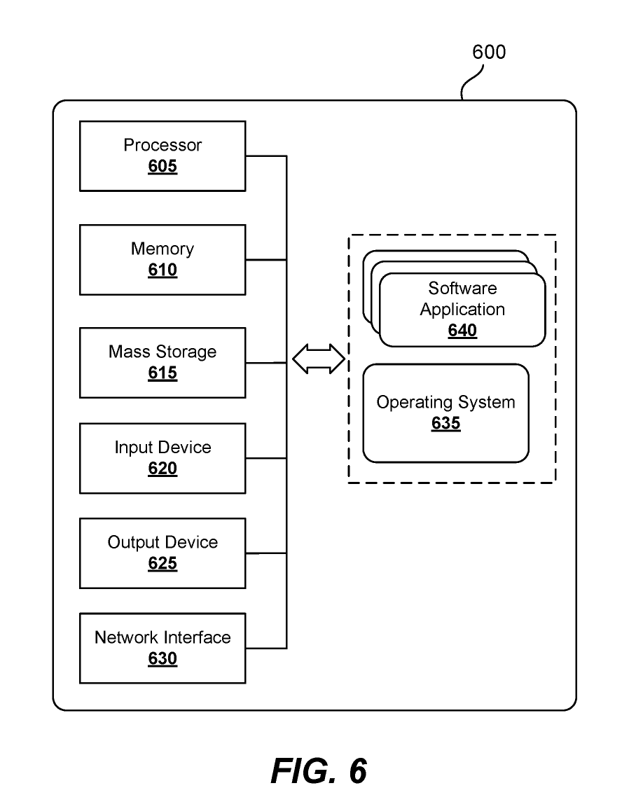

FIG. 6 is a high-level block diagram illustrating an example computer system 600 suitable for implementing the method for providing a location-based gaming experience as described herein. The computer system 600 may include, refer to, or be an integral part of one or more of a variety of types of devices, such as a general-purpose computer, desktop computer, laptop computer, tablet computer, netbook, mobile phone, smartphone, personal digital computer, smart television device, server, among others. In some embodiments, the computer system 600 is an example of mobile device 110 or server 105. Notably, FIG. 6 illustrates just one example of the computer system 600 and, in some embodiments, the computer system 600 may have fewer elements/modules than shown on FIG. 6 or more elements/modules than shown on FIG. 6.

The computer system 600 includes one or more processors 605, a memory 610, one or more storage devices 615, one or more input devices 620, one or more output devices 625, and network interface 630. One or more processors 605 are, in some examples, configured to implement functionality and/or process instructions for execution within the computer system 600. For example, the processors 605 may process instructions stored in memory 610 and/or instructions stored on storage devices 615. Such instructions may include components of an operating system 635 or software applications 640. Computer system 600 may also include one or more additional components not shown in FIG. 6, such as a housing, power supply, battery, global positioning system (GPS) receiver, and so forth.

Memory 610, according to one example, is configured to store information within the computer system 600 during operation. Memory 610, in some example embodiments, may refer to a non-transitory computer-readable storage medium or a computer-readable storage device. In some examples, memory 610 is a temporary memory, meaning that a primary purpose of memory 610 may not be long-term storage. Memory 610 may also refer to a volatile memory, meaning that memory 610 does not maintain stored contents when memory 610 is not receiving power. Examples of volatile memories include random access memories (RAM), dynamic random access memories (DRAM), static random access memories (SRAM), and other forms of volatile memories known in the art. In some examples, memory 610 is used to store program instructions for execution by the processors 202. Memory 610, in one example, is used by software (e.g., the operating system 635 or applications 640). Generally, software applications 640 refer to software applications suitable for implementing at least some operations of the methods for providing a location-based gaming experience as described herein.

One or more storage devices 615 can also include one or more transitory or non-transitory computer-readable storage media and/or computer-readable storage devices. In some embodiments, storage devices 615 may be configured to store greater amounts of information than memory 610. Storage devices 615 may further be configured for long-term storage of information. In some examples, the storage devices 615 include non-volatile storage elements. Examples of such non-volatile storage elements include magnetic hard discs, optical discs, solid-state discs, flash memories, forms of electrically programmable memories (EPROM) or electrically erasable and programmable memories, and other forms of non-volatile memories known in the art.

Still referencing to FIG. 6, the computer system 600 may also include one or more input devices 620. The input devices 620 may be configured to receive input from a user through tactile, audio, video, or biometric channels. Examples of input devices 620 may include a keyboard, keypad, mouse, trackball, touchscreen, touchpad, microphone, one or more video cameras, image sensors, fingerprint sensors, or any other device capable of detecting an input from a user or other source, and relaying the input to computer system 600, or components thereof.

The output devices 625, in some examples, may be configured to provide output to a user through visual or auditory channels. Output devices 625 may include a video graphics adapter card, a liquid crystal display (LCD) monitor, a light emitting diode (LED) monitor, an organic LED monitor, a sound card, a speaker, a lighting device, a LED, a projector, or any other device capable of generating output that may be intelligible to a user. Output devices 625 may also include a touchscreen, presence-sensitive display, or other input/output capable displays known in the art.

The computer system 600, in some example embodiments, also includes network interface 630. The network interface 630 can be utilized to communicate with external devices via one or more data networks such as one or more wired, wireless, or optical networks including, for example, the Internet, intranet, LAN, WAN, cellular phone networks, Bluetooth radio, and an IEEE 802.11-based radio frequency network, among others. The network interface 630 may be a network interface card, such as an Ethernet card, an optical transceiver, a radio frequency transceiver, or any other type of device that can send and receive information.

The operating system 635 may control one or more functionalities of computer system 600 and/or components thereof. For example, the operating system 635 may interact with the applications 640 and may facilitate one or more interactions between the applications 640 and components of the computer system 600. As shown in FIG. 6, the operating system 635 may interact with or be otherwise coupled to the application(s) 640 and components thereof. In some embodiments, application(s) 640 may be included in operating system 635. In these and other examples, virtual modules, firmware, or software for vehicle identification may be part of the applications 640.

Example Gameplay Scenarios

An example gameplay can be started with an animation displaying on a display of a mobile device a seed that comes into a contact with a ground causing the seed to transform into a tree, which grows over time. Further, the player can be provided with a tutorial displayed on another screen of the mobile device. The tutorial can explain to the player that the tree needs water to grow and live, and further inviting the player to perform game actions to acquire water to fulfil the tree's needs. If the player can acquire the water as needed, the player is granted game points. The game points of players from the same predetermined geographical area can be then automatically aggregated regularly. The tutorial can further explain that the player can defend his tree or a predetermined part of the tree from attacks of other players. In addition, the player can virtually attack the game objects (i.e., trees) of other players from other geographical locations.

In example embodiments, the gameplay can involve several different types of game points or in-game currency. The game points can include, for example, “crystals,” “coins,” “water,” “sun,” and “fertilizers.” These game points can have different in-game value and can be used to improve a portion of tree belonging to the player. In addition, the game points can include “growth points,” which are universal in the sense that they reflect the progress in the development of the tree or the part of the tree that is associated with the player. The growth points also cause the growth of the “alliance” tree that are managed by a group of the players from the same predetermined geographical location. In addition, the game points can include “mood points,” which can be acquired for the repletion of needs of the tree by a player. The game points are given to the player for playing different games, for satisfying the needs or requirements of the tree, watching videos or commercials, connecting the game to social media, inviting friends to play in the game, web sharing, leaving feedback, and the like.

In general, the player needs to regularly take care of the tree and spend some game points to keep it in a good shape or keep it growing. The tree can behave as a game character inviting the player to play one or more games with the player, pass quests, and the like. The tree can be associated with a progress bar or any other graphical indicia showing the level of the tree development. For example, when a marker on the progress bar is in the red zone, the player should understand that the tree is growing too slow. In contrast, when the marker on the progress bar is in the green zone, the player should understand that the tree is growing at a normal pace. The tree may also have some “needs” that should be addressed or satisfied by the player. When these needs are addressed or satisfied by the player, the player can be granted in-game currency.

In certain embodiments, the GUI of the game can include the following elements: a background (e.g., predetermined image or video, or real-time image acquired from a camera), the tree image or its portion associated with the player, a progress bar, one or more counts of game points or in-game currency, a menu button, an online store button, a camera button, a mini-game button, a button for solving current needs of the tree, a button that leads to an image of the tree or other trees of other players, and so forth. During the gameplay, one or more game tasks can be created and displayed for the player to accomplish. When these game tasks are successfully completed, the tree is maintained in a good condition even allow the tree to grow or improve. In other instances, the player can perform game tasks, challenges or quests to acquire growth points.

During the gameplay, the rank of each player can be also calculated based on his growth points or other game points. In addition, a rank of a group of players associated with the same game object (i.e., the same tree) can be also calculated. Moreover, the rank of all players from a given country can be also calculated for further display and comparison to ranks of other locations.

As discussed above, the tree can have one or more needs or requirements that can be presented to the player randomly or in a predetermined manner based on a level of the player. When these needs are satisfied by the player, the player is provided with additional game points such as mood points or growth points. If the needs are not satisfied within a predetermined period, previously earned mood points can automatically decrease. In some embodiments, the needs can be solved by the player by paying one or more game points. For example, the player may need to spend some “water” points and “coin points” to fulfil a predetermined need of the tree to get mood points. Some of the tree needs must be fulfilled by the player witching predetermined periods, while other needs may not need to be satisfied by a predetermined deadline.

During the gameplay, the tree is subject to one or more predetermined weather conditions. These weather conditions can change from time to time in a random or predetermined fashion. For example, the weather conditions can include a sunny condition, a cloudy condition, a raining condition, a storm condition, a hailing condition, a fog condition, a heat condition, and the like. The players may need to defend the tree from some of these weather conditions by performing game tasks or making purchasing decisions with in-game currency or real currency. For example, the player can buy a virtual umbrella to save the tree from rain or heat. In yet additional embodiments, the mood points or any other game point can be constantly decreasing (e.g., at the pace of 60 mood points per hour). In these embodiments, the players need to repeatedly perform certain game tasks, pass levels, challenges, and the like to increase the mood points and allowing them to decrease down to a predetermined limit.

Some of the game GUIs can also include one or more virtual buildings that the player can build or purchase with in-game currency or real currency. The virtual buildings can generate certain game points such as repeatedly generate water points or fertilizer points. From time to time, the players can upgrade the virtual buildings. Moreover, the players can acquire “artefacts” for completing certain game tasks. These artefacts can improve or accelerate production of the game points by the buildings. In yet more embodiments, the player can use online store for making purchases with in-game points or real currency. The player can also visit an online bank for managing the game points, perform exchanges, and the like.

In yet more embodiments, the player can control one or more virtual characters such as bugs or insects. The virtual characters can be used to defend the tree of attack a tree of another.

In additional embodiments, the gameplay includes augmented reality features, which can invite the player to travel around a predetermined geographical area with the mobile device to find one or more seeds, artefacts, virtual characters, game points, and so forth. For example, the player may need to visit a predetermined location in his city with the mobile device and “check-in” the location to acquire a new virtual seed that can be used in the game. This virtual seed can be seen on the display of the mobile device augmented over real time image acquired by the camera of the mobile device.

### CONCLUSION

Thus, methods and systems for providing a location-based gaming experience have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A system for providing a location-based gaming experience, the system comprising:
a server maintaining a plurality of pools of game points associated with a plurality of players and a plurality of geographical areas; and
a first mobile device in operative communication with the server, wherein the first mobile device includes a memory module and a processor configured to:
determine a first geographical location of a first player, wherein the first geographical location is associated with a first geographical area;
obtain from the server a first game object associated with the first geographical area;
display the first game object to the first player;
associate the first player with a portion of the first game object;
enable the first player to play one or more games to acquire game points, wherein the server further causes modifying the portion of the first game object associated with the first player in accordance with the game points of the first player, and wherein the modified game object is displayable on mobile devices of other players associated with the first geographical area.

2. The system of claim 1, further comprising:
a second mobile device in operative communication with the server, wherein the second mobile device includes a memory module and a processor configured to:
determine a second geographical location of a second player, wherein the second geographical location is associated with a second geographical area, wherein the second geographical area differs from the first geographical area;
obtain from the server a second game object associated with the second geographical area;
display the second game object;
associate the second player with a portion of the second game object;
enable the second player to play one or more games to acquire game points, wherein the server further causes modifying the portion of the second game object associated with the second player in accordance with the game points of the second player, wherein the modified second game object is displayable on mobile devices of other players associated with the first geographical area and on mobile devices of other players associated with the second geographical area.

3. The system of claim 2, wherein the server is further configured to:
add the game points of the first player to a first pool of game points;
add game points of other players from the first geographical area to the first pool of game points;
repeatedly calculate a game points count in the first pool of game points;
compare the game points count from the first pool with one or more other game points counts associated with players from other geographical areas and not associated with the first geographical area; and
based on the comparing, select a winning geographical area among a plurality of geographical areas.

4. The system of claim 3, wherein the server is further configured to award a monetary or non-monetary award to the winning geographical area.

5. The system of claim 3, wherein the server is further configured to:
enable the first player to at least partially reverse the modification of the portion of the second game object associated with the second player based on game interactions or monetary purchases made by the first player; and
enable the second player to at least partially reverse the modification of the portion of the first game object associated with the first player based on game interactions or monetary purchases made by the second player.

6. A method, the method comprising:
determining a first geographical location of a first player, wherein the first geographical location is associated with a first geographical area;
obtaining a first game object associated with the first geographical area;
displaying the first game object to the first player;
associating the first player with a portion of the first game object;
enabling the first player to play one or more games to acquire game points; and
modifying the portion of the first game object associated with the first player in accordance with the game points, wherein the modified game object is displayable on mobile devices of other players associated with the same first geographical area.

7. The method of claim 6, wherein the first game object is displayed to the player using augmented reality.

8. The method of claim 6, wherein the first game object is a three-dimensional object.

9. The method of claim 6, further comprising:
adding the game points of the first player to a pool of game points;
adding game points of other players from the first geographical area to the pool of game points;
repeatedly calculating a game points count in the pool of game points;
comparing the game points count with one or more other game points counts associated with players from other geographical areas not associated with the first geographical area; and
based on the comparing, selecting a winning geographical area among a plurality of geographical areas.

10. The method of claim 9, further comprising awarding a monetary or non-monetary award to the winning geographical area.

11. The method of claim 6, further comprising:
associating the first player with the first geographical area and a first sub-geographical area, wherein the first sub-geographical area is smaller than the first geographical area and is located within the first geographical area;
associating a first group of other players with the first sub-geographical area based on their geographical locations; and
enabling to collectively modify the same portion of the first game object associated with the first player and the first group of other players based on game points acquired by the first player and the first group of other players.

12. The method of claim 11, wherein the first geographical area refers to a city, a town, or a village, and wherein the first sub-geographical area refers to a street, a district or a neighborhood of the first geographical area.

13. The method of claim 12, wherein the first game object includes a tree and the portion of the first game object refers to a branch of the tree.

14. The method of claim 13, wherein the modifying of the portion of the first game object includes creating or editing one or more features of the branch of the tree.

15. The method of claim 14, wherein the one or more features of the branch of the tree include leaves of the tree.

16. The method of claim 6, further comprising:
enabling the first player to make monetary purchases; and
modifying the portion of the first game object based on the monetary purchases.

17. The method of claim 6, further comprising:
determining a second geographical location of a second player, wherein the second geographical location is associated with a second geographical area;
obtaining a second game object associated with the second geographical area;
displaying the second game object using augmented reality;
associating the second player with a portion of the second game object;
enabling the second player to play one or more games to acquire game points; and
modifying the portion of the second game object associated with the second player in accordance with the game points, wherein the modified game object is displayable on mobile devices of other players associated with the first geographical area and on mobile devices of other players associated with the second geographical area.

18. The method of claim 17, further comprising:
enabling the first player to at least partially reverse the modification of the portion of the second game object associated with the second player based on game interactions or monetary purchases made by the first player; and
enabling the second player to at least partially reverse the modification of the portion of the first game object associated with the first player based on game interactions or monetary purchases made by the second player.

19. The method of claim 6, further comprising:
assigning a predetermined status to the first player based on the game points and monetary transactions of the first player; and
providing additional games or game features to the first player based on the predetermined status to the first player.

20. A non-transitory processor-readable medium having instructions stored thereon, which when executed by one or more processors, cause the one or more processors to implement a method for providing a location-based gaming experience, the method comprising:
determining a first geographical location of a first player, wherein the first geographical location is associated with a first geographical area;
obtaining a first game object associated with the first geographical area;
displaying the first game object to the first player;
associating the first player with a portion of the first game object;
enabling the first player to play one or more games to acquire game points; and
modifying the portion of the first game object associated with the first player in accordance with the game points, wherein the modified game object is displayable on mobile devices of other players associated with the same first geographical area.
